(19) United States
(12) Patent Application Publication
(10) Pub. No.: US 2024/0066630 A1
(43) Pub. Date: Feb. 29, 2024

(54) LASER DEVICE FOR GENERATING LASER RADIATION AND 3D PRINTING DEVICE COMPRISING SUCH A LASER DEVICE

(71) Applicant: LIMO GMBH, Dortmund (DE)

(72) Inventors: Aliaksei KRASNABERSKI, Dortmund (DE); Stephan SCHNEIDER, Dortmund (DE)

(21) Appl. No.: 17/766,506

(22) PCT Filed: Oct. 6, 2020
(86) PCT No.: PCT/EP2020/077999

§ 371 Date: Apr. 4, 2022

(30) Foreign Application Priority Data
Oct. 7, 2019 (DE) 10 2019 126 888.5
Dec. 20, 2019 (DE) 10 2019 135 446.3

(51) Int. Cl. B23K 26/067; B23K 26/064; B23K 26/073; B33Y 30/00

(52) U.S. Cl. CPC B23K 26/0676; B23K 26/064; B23K 26/073; B33Y 30/00

(57) ABSTRACT

Laser device for generating laser radiation which has an intensity distribution with a plurality of intensity maxima in a working plane (11), comprising a laser light source (1) which, during operation of the laser device, emits a laser radiation (2) which, in a first plane (5), forms a line-shaped or area-shaped intensity distribution (6) with a plurality of intensity maxima (7), the intensity maxima (7) being at least partially at a first distance (d1) from one another in at least one transverse direction, which is perpendicular to the propagation direction of the laser radiation (2), are at least partially at a first distance (d1) from one another, and furthermore comprising a projection device (8) which images the first plane (5) into the working plane (11) in such a way that a linear or planar intensity distribution (6′) with a plurality of intensity maxima (7′) is formed in the working plane (11).

### TECHNICAL FIELD

The present invention relates to a laser device for generating laser radiation having an intensity distribution with a plurality of intensity maxima in a working plane, and to a 3D printing device comprising such a laser device.

### SUMMARY

Definitions: In the direction of propagation of the laser radiation means mean direction of propagation of the laser radiation, especially when it is not a plane wave or is at least partially divergent. By laser beam, light beam, partial beam or beam, unless explicitly stated otherwise, is not meant an idealized beam of geometrical optics, but a real light beam, such as a laser beam with a Gaussian profile or a modified Gaussian profile, which does not have an infinitesimally small but an extended beam cross-section. By M-profile is meant an intensity profile of laser radiation whose cross-section has a lower intensity in the center than in one or more off-center regions. By top-hat distribution or top-hat intensity distribution or top-hat profile is meant an intensity distribution which, at least with respect to one direction, can essentially be described by a rectangular function (rect (x)). In this context, real intensity distributions which show deviations from a rectangular function in the percentage range or inclined edges, respectively, shall also be referred to as top-hat distribution or top-hat profile.

A laser device of the type mentioned above, and a 3D printing device of the type mentioned above are known, for example, from WO 2015/134075 A2. In the 3D printing device described therein, a plurality of semiconductor lasers is used whose light is coupled into a plurality of optical fibers. The laser radiation emerging from the optical fibers is used to selectively impact a starting material for 3D printing, which is arranged in a working area of the 3D printing device.

A disadvantage of laser devices known in the prior art and 3D printing devices with optical fibers, from which the laser radiation required for 3D printing emerges, is that usually only a small working distance can be achieved. This can lead to damage or contamination of the optics used. Furthermore, distances result between the individual pixels used for 3D printing because the distances between the cores of the optical fibers are comparatively large and the claddings of adjacent optical fibers are arranged between the cores. Furthermore, the pixel size is often too large, so that good resolution cannot be achieved.

The problem underlying the present invention is the creation of a laser device of the type mentioned above, as well as a 3D printing device of the type mentioned above, which enable a smaller pixel size in the working plane and/or a larger working distance.

According to the invention, this is achieved by a laser device of the type mentioned above with the features of claim 1 as well as by a 3D printing device of the type mentioned above with the features of claim 28. The sub claims concern preferred embodiments of the invention.

According to claim 1, it is provided that the laser device comprises a laser light source which, during operation of the laser device, emits a laser radiation which, in a first plane, forms a linear or planar intensity distribution having a plurality of intensity maxima, the intensity maxima being at least partially at a first distance from one another in at least one transverse direction, which is perpendicular to the mean propagation direction of the laser radiation, at least partially having a first distance from one another, the laser device further comprising a projection device which images the first plane into the working plane in such a way that a line-shaped or area-shaped intensity distribution having a plurality of intensity maxima is formed in the working plane.

In particular, the intensity maxima of the intensity distribution in the first plane can be at least partially at a first distance from one another in at least one transverse direction that is perpendicular to the propagation direction of the laser radiation, wherein the projection device can image the first plane into the working plane in a reduced form such that the intensity maxima of the intensity distribution in the working plane are at least partially at a second distance from one another in at least one transverse direction that is perpendicular to the propagation direction of the laser radiation, which second distance is smaller than the first distance. Thereby, the intensity maxima in the working plane in the at least one transverse direction may all have the second distance to each other. Further, the reduction achieved by the projection device may be between 1 and 20.

The reduction can significantly reduce the size of the intensity maxima or the pixel size in the working plane. The distances between the individual intensity maxima can also be reduced as a result. In particular, the gaps between the intensity maxima can be filled accordingly. For example, the pixel size can be significantly smaller than 100 μm or even smaller than the diameter of the cores of the optical fibers. It may be provided that the working distance between the projection device and the working plane is greater than 50 mm, in particular greater than 100 mm, preferably equal to or greater than 200 mm. In particular, a reducing projection device increases the working distance accordingly, so that distances of more than 200 mm can be achieved, for example. Thus, damage or contamination of the optics used can be avoided. Furthermore, this results in an increased depth of field in the working plane.

Alternatively, it can be provided that the intensity maxima of the intensity distribution in the first plane in at least one transverse direction, which is perpendicular to the propagation direction of the laser radiation, are at least partially at a first distance from one another, wherein the projection device can image the first plane into the working plane in such a way that the intensity maxima of the intensity distribution in the working plane in at least one transverse direction, which is perpendicular to the propagation direction of the laser radiation, are at least partially at a second distance from one another, which is greater than the first distance or which is equal to the first distance. In this respect, the projection device may, for example, achieve a magnification of between 1 and 5 or a magnification of 1.

It may be provided that the projection device is a telecentric projection device, in particular a bilateral telecentric projection device. By means of a telecentric projection device, uniform angular distributions of the laser radiation in the working plane can be achieved. The uniform angular distributions lead to uniform temperature distributions of the starting material to be heated during 3D printing.

It is possible that at least one component of the projection device is cylindrically shaped. Alternatively or additionally, at least one component of the projection device may be cylindrically or spherically or aspherically shaped. It may further be provided that the at least one component of the projection device is a microlens array.

It may be provided that the at least one microlens array is a refractive, reflective, or holographic optical element, or is a continuous surface optical element, or is a binary optical element, or is a multilevel diffractive optical element.

It is possible for the laser light source to comprise at least one fiber laser. Alternatively, other laser light sources such as laser diode bars or the like may be provided.

It may be provided that the laser light source comprises a plurality of optical fibers, from the ends of each of which a partial beam of laser radiation emerges, the optical fibers being in particular single-mode fibers or large-mode area fibers or Few-mode fibers. The diffraction index M2 of such light sources may be less than 2, preferably less than 1.5, particularly for use with a converter.

The laser light source may have a holder with a plurality of grooves, in particular V-shaped grooves, wherein each of the optical fibers is arranged in one of the grooves. By being held in V-grooves, the optical fibers can be precisely positioned with respect to each other. As a result, a very constant overlap of the individual intensity maxima of, for example, only 1 μm in the working plane can be realized. To improve the accuracy of the positioning, the part of the holder having the V-grooves can be formed in one piece.

Alternatively, it can be provided that a one-dimensional or two-dimensional array of optical fibers is formed by connecting the optical fibers or their ends directly, for example by bonding and/or splicing, to an optical component or to a window, in particular wherein the connection of the optical fibers to the optical component or to the window creates a, preferably one-piece, optical component. The optical component may be the first optical component arranged downstream of the laser light source in the direction of propagation of the laser radiation. For example, the window may be part of a fiber holder or fiber carrier.

It is possible that the intensity maxima generated in the first plane are each formed by the partial radiation emerging from one of the optical fibers. Suitable optical means may be provided to focus the partial radiations in the first plane.

It may be provided that the partial radiations in the individual optical fibers have a mode profile corresponding to a Bessel profile or a Gaussian profile or an M-profile or a top-hat profile. Furthermore, the intensity maxima in the working plane may each have a Gaussian profile or a supergaussian profile or a top-hat profile or an M-profile or a process-optimized profile. In particular, any profile can be generated in the working plane that may differ from the aforementioned profiles. Preferably, the profile of the intensity distributions can be changed depending on the materials to be processed.

It is possible that the laser device comprises at least one converter capable of changing the intensity profile of the laser radiation or of one or more of the partial beams, the converter being capable, for example, of converting a Gaussian profile into a top-hat profile.

It may be provided that the at least one converter is formed as a 2D Gaussian-to-Airy disc function converter, in particular as an axially symmetric binary phase plate, or that the at least one converter is formed as a 1D Gaussian-to-sinc function converter, in particular as two cylindrical binary phase plates aligned perpendicular to each other.

In particular, a plurality of converters may be provided, arranged in a one-dimensional array or a two-dimensional array. Such an array of converters could be arranged between the laser light source and the projection device.

It may be envisaged that the at least one converter is integrated into the projection device. In this case, a single converter could be used instead of an array of converters.

It is possible that the intensity maxima in the working plane each have a circular outline or a square outline or a hexagonal outline. For example, square outlines are advantageous because gaps can be avoided between them. Adaptation to the materials to be processed can also be made by changing the shape of the pixels in the working plane.

It may be provided that the laser device comprises at least one collimation element, in particular a plurality of collimation elements, for collimating the laser radiation emerging from the laser light source. Thereby, the plurality of collimation elements may be arranged in a one-dimensional array or a two-dimensional array, which is in particular a lens array. The collimating elements may reduce the divergence of the laser radiation. If the collimation elements are designed as a crossed cylindrical lens, gaps between individual partial beams can be reduced.

It is possible for the plurality of intensity maxima in the working plane to be switched on or off individually or in groups, in particular by controlling the laser light source accordingly. This results in individually addressable pixels in the working plane for 3D printing. In particular, the individual pixels or intensity maxima in the working plane can have up to several 100 W of power per pixel.

With a laser device according to the invention, line-shaped or area-shaped intensity distributions can be generated in the working plane.

It can be provided that the laser device comprises means for superimposing individual partial beams emanating from the laser light source into individual pixels in the first plane and/or that the laser device comprises means for splitting individual or all partial beams emanating from the laser light source into several pixels in the first plane.

The superposition can be achieved, for example, in a geometric or optical manner. Alternatively, superposition can also be achieved via polarization couplers or wavelength couplers. The superposition of several partial beams to form a pixel can be advantageous, for example, to enable power scaling or to reduce the loads on critical optical elements or to have one or more spare channels in case of failure of individual channels.

Splitting partial beams into multiple pixels can be advantageous, for example, in parallel processing.

It is possible that the laser device comprises at least one Fourier lens and/or at least one array of Fourier lenses, which are arranged in particular between the laser light source and the first plane. The at least one Fourier lens and/or the at least one array of Fourier lenses may, for example, serve as a means for superimposing individual partial beams emanating from the laser light source into individual pixels in the first plane.

According to claim 28, it is provided that the laser device is a laser device according to the invention. A laser device according to the invention represents an industrially very attractive solution with which, in particular, 3D printing with metallic starting materials can be carried out.

In this context, the working plane of the laser device can correspond to the working area of the 3D printing device. The scanning device can be designed such that the laser radiation is moved relative to the working area or the working area is moved relative to the laser radiation.

In particular, the laser radiation generated by the laser device can thereby be deflected by the scanning device as a whole, wherein the scanning device is configured, for example, as a galvanoscanner. This is possible in particular because of the good beam quality that can be generated with the laser device according to the invention, the large working distance and the large depth of field in the working plane.

There is therefore no need to deflect each individual partial beam with, for example, a single mirror.

### BRIEF DESCRIPTION OF FIGURES

Further features and advantages of the present invention will become apparent from the following description of preferred embodiments with reference to the accompanying figures. Therein show:

FIG. 1 a schematic side view of a first embodiment of a laser device according to the invention;

FIG. 2a a first intensity distribution of a laser radiation generated in a working plane by a laser device according to the invention;

FIG. 2b a second intensity distribution of a laser radiation generated with a laser device according to the invention in a working plane;

FIG. 3a a third intensity distribution of a laser radiation generated with a laser device according to the invention in a working plane;

FIG. 3b a fourth intensity distribution of a laser radiation generated with a laser device according to the invention in a working plane;

FIG. 4 a fifth intensity distribution of a laser radiation generated with a laser device according to the invention in a working plane;

FIG. 5 a schematic side view of a second embodiment of a laser device according to the invention;

FIG. 6 a schematic side view of a third embodiment of a laser device according to the invention;

FIG. 7a a sixth intensity distribution of a laser beam generated in a working plane by a laser device according to the invention;

FIG. 7b a diagram illustrating the sixth intensity distribution according to FIG. 7a;

FIG. 7c a seventh intensity distribution of a laser radiation generated in a working plane with a laser device according to the invention;

FIG. 7d a diagram illustrating the seventh intensity distribution according to FIG. 7c;

FIG. 8 a schematic side view of a fourth embodiment of a laser device according to the invention;

FIG. 9 a schematic side view of a fifth embodiment of a laser device according to the invention;

FIG. 10 a schematic side view of a sixth embodiment of a laser device according to the invention;

FIG. 11 a schematic side view of a seventh embodiment of a laser device according to the invention;

FIG. 12 a schematic side view of an eighth embodiment of a laser device according to the invention;

FIG. 13 a schematic side view of a ninth embodiment of a laser device according to the invention;

FIG. 14 a schematic side view of a tenth embodiment of a laser device according to the invention;

FIG. 15 a schematic side view of an eleventh embodiment of a laser device according to the invention;

FIG. 16 an eighth intensity distribution of a laser beam generated in a working plane by a laser device according to the invention;

FIG. 17 a schematic side view of a twelfth embodiment of a laser device according to the invention;

FIG. 18 a schematic side view of a detail of a first embodiment of a 3D printing device according to the invention;

FIG. 19 a schematic side view of a detail of a second embodiment of a 3D printing device according to the invention;

FIG. 20 a schematic side view of a detail of a third embodiment of a 3D printing device according to the invention;

FIG. 21a a schematic side view of a first embodiment of a projection device of a laser device according to the invention, wherein some exemplary beams of a laser radiation moving through the projection device are drawn;

FIG. 21b a schematic side view of the projection device according to FIG. 21a, in which the laser radiation moving through the projection device is drawn;

FIG. 21c a schematic side view of the projection device according to FIG. 21a rotated by 90°, in which the laser radiation moving through the projection device is drawn;

FIG. 22a a schematic side view of a second embodiment of a projection device of a laser device according to the invention, wherein some exemplary beams of a laser radiation moving through the projection device are drawn;

FIG. 22b a schematic side view of the projection device according to FIG. 22a, in which the laser radiation moving through the projection device is drawn;

FIG. 22c a schematic side view of the projection device according to FIG. 22a rotated by 90°, in which the laser radiation moving through the projection device is drawn;

FIG. 23a a schematic side view of a third embodiment of a projection device of a laser device according to the invention, wherein some exemplary beams of a laser radiation moving through the projection device are drawn;

FIG. 23b a schematic side view of the projection device according to FIG. 23a, in which the laser radiation moving through the projection device is drawn;

FIG. 23c a schematic side view of the projection device according to FIG. 23a rotated by 90°, in which the laser radiation moving through the projection device is drawn;

FIG. 24 a schematic side view of a detail of a thirteenth embodiment of a laser device according to the invention.

In the figures, identical or functionally identical parts are given the same reference signs. A Cartesian coordinate system is drawn in some of the figures.

### DETAILED DESCRIPTION

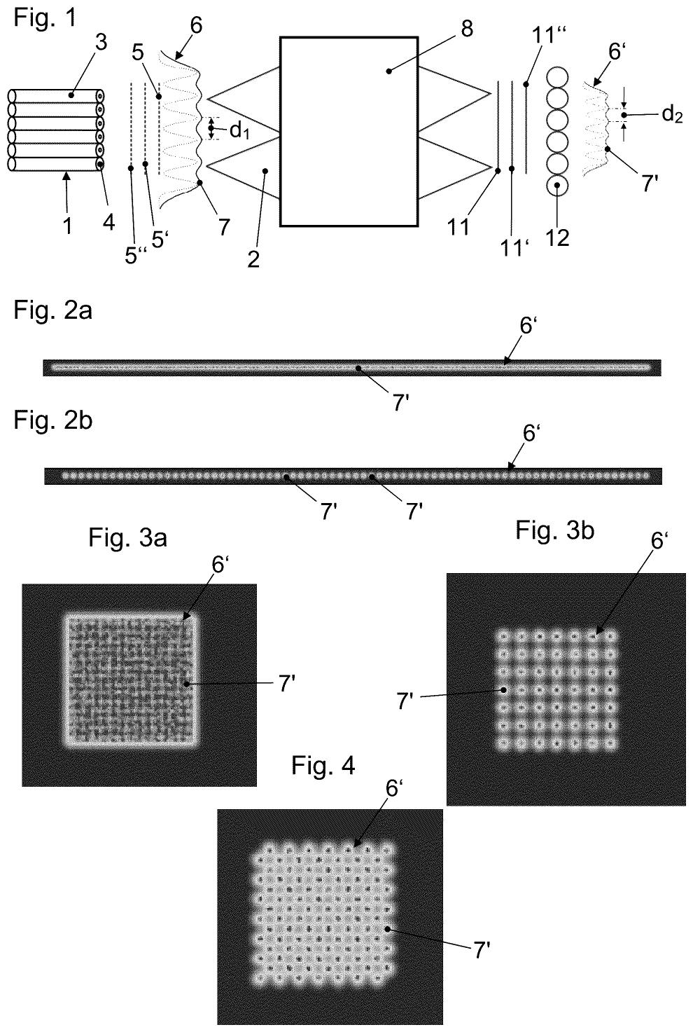

The first embodiment of a laser device according to the invention illustrated in FIG. 1 comprises a laser light source 1 for generating a laser radiation 2 merely schematically indicated in FIG. 1. The laser light source 1 is designed in particular as an array of lasers, preferably as an array of fiber lasers with a plurality of optical fibers 3, from each of which a partial radiation of the laser radiation 2 emerges. The continuous wave output power of the laser light source 1 can be, for example, between 1 W and 1000 W. The wavelength of the laser radiation 2 emitted by the laser light source 1 may be, for example, 1080 nm.

Alternatively, it may be provided that instead of a plurality of fiber lasers, a plurality of other lasers such as a laser diode bar having a plurality of emitters is provided, the light from each of which is coupled into an optical fiber.

In the illustrated embodiment example, the optical fibers 3 are arranged side by side in a direction corresponding to the vertical direction in FIG. 1. This results in a one-dimensional array of optical fibers 3, from the ends of which one of the partial beams emerges in each case. The center-to-center spacing of the optical fibers can be between 20 μm and several millimeters.

Alternatively, the optical fibers 3 may not be arranged next to each other in one direction but in two directions, in particular perpendicular to each other. In this case, the result is a two-dimensional array of optical fibers 3 from each of whose ends one of the partial beams emerges. Here, too, the center-to-center spacing of the optical fibers can be between 20 μm and several millimeters.

In particular, the laser light source 1 comprises a holder, which is not shown, with a plurality of V-shaped grooves arranged equidistantly from one another. Thereby, each of the optical fibers 3 is arranged in one of the grooves. The holder can be made of silicone or glass in particular.

This holding in V-grooves allows the optical fibers 3 to be positioned precisely with respect to each other. In order to improve the accuracy of the positioning, the part of the holder having the V-grooves can be formed in one piece.

Alternatively, it is possible to form a one-dimensional or two-dimensional array of optical fibers by connecting the optical fibers or their ends directly to an optical component, for example by bonding and/or splicing. The optical component may be the first optical component arranged downstream of the laser light source in the direction of propagation of the laser radiation. Alternatively, the optical fibers can also be connected to a window, which is part of a fiber holder or fiber carrier, for example. In particular, by connecting the optical fibers to the optical component or the window, an optical component, preferably in one piece, can be created.

The diameter of the core 4 of the optical fibers 3 indicated in FIG. 1 can be between a few μm and 100 μm or more. The mode profile of the laser radiation in each of the optical fibers 3 may be a Bessel profile or a Gaussian profile or a quasi-Gaussian profile or an M-profile.

The laser radiation 2 emerging from the fiber ends forms in a first plane 5 an intensity distribution 6 schematically indicated in FIG. 1, which has a plurality of spaced intensity maxima 7. The intensity maxima 7 can each have a Gaussian profile, for example. Each of these intensity maxima 7 is formed by one of the partial beams emerging from one of the ends of the optical fibers 3. The half-width (FWHM) of the individual intensity maxima 7 can be between 10 μm and more than 1 mm. The first distance d1 of these intensity maxima 7 from each other is indicated in FIG. 1.

The laser device further comprises a projection device 8, which is only indicated by a rectangle in FIG. 1. The projection device 8 is in particular a telecentric, preferably a bilateral telecentric projection device. The numerical aperture of the projection device 8 may be between 0.001 and 0.1 or more.

The projection device 8 may comprise at least one refractive component and/or at least one diffractive component and/or at least one reflective component. It is possible that at least one component of the projection device is cylindrical or spherical or aspherical in shape. It is possible to provide that at least one component of the projection device 8 is a microlens array.

The at least one microlens array may be a refractive, reflective, or holographic optical element, or may be an optical element having a continuous surface, or may be a binary optical element or a multilevel diffractive optical element.

The projection device 8 may include at least one component that is used to correct chromatic aberration. The projection device 8 may include a zoom function to adjust the size of pixels in the working plane or line sizes. The projection device 8 may include at least one component serving to fold the beam path, such as a mirror, to reduce the length of the projection device. To project laser beams with powers of, for example, more than 10 kW, the projection device 8 may comprise at least one component with a cooling function.

Examples of complexly constructed projection devices can be found in DE198 184 44 A1 and U.S. Pat. No. 6,560,031 B1.

The first embodiment of a projection device 8 shown in FIG. 1 images the first plane 5 into the working plane 11. In doing so, the projection device 8 performs a reduced imaging. The intensity distribution 6′ of the laser radiation 2 in the working plane 11 is thereby compressed compared to the intensity distribution 6 in the first plane 5. The second distance d2 of the intensity maxima 7′ from each other in the working plane 11 is smaller than the first distance d1 of the intensity maxima 7 in the first plane 5. The reduction in size of the projection device 8 can be, for example, between 1 and 20.

The projection device 8 further increases the working distance of the working plane 11 from the laser device. The size of the intensity maxima 7′ in the working plane 11 can also be influenced by selecting a working plane spaced from the working plane 11, into which a plane adjacent to the first plane is imaged. In FIG. 1, two planes 5′, 5″ adjacent to the first plane 5 and two planes 11″, 11′ adjacent to the working plane 11 are drawn as examples for this purpose.

The intensity maxima 7′ of the laser radiation generated in the working plane 11 can be regarded as pixels of a laser radiation used for a 3D printing device for generating a spatially extended product. For this purpose, the working plane 11 can be arranged in a working area of a 3D printing device, whereby the working area can be supplied with starting material to be exposed to the laser radiation for 3D printing.

The individual intensity maxima 7′ or pixels of the laser radiation 2 used for 3D printing can be switched on and off in a targeted manner. This switching on or off of the pixels can be achieved in particular by appropriate control of the laser light source 1. For example, individual ones of the fiber lasers can be switched on or off for this purpose.

The cross-section of the intensity maxima 7′ or of the pixels is circular in the embodiment according to FIG. 1. The cross-section is indicated in FIG. 1 by the circles 12 arranged next to each other.

FIG. 2a shows a line-shaped intensity distribution 6′ of the laser radiation 2 in the working plane 11 in a state in which all pixels or intensity maxima 7′ are present. In contrast, FIG. 2b shows the intensity distribution 6′ in a state in which every second pixel is off.

FIG. 3a and FIG. 3b show a similar comparison for a laser device that generates an planar intensity distribution 6′ in the working plane 11. Here, the individual pixels or intensity maxima 7′ are arranged side by side in two mutually perpendicular directions lying in the drawing plane. FIG. 3a shows the intensity distribution 6′ of the laser radiation 2 in the working plane 11 in a state in which all pixels or intensity maxima 7′ are present. In contrast, FIG. 3b shows the intensity distribution 6′ in a state in which every second pixel is off.

FIG. 4 shows an area-shaped intensity distribution 6′ in the working plane 11, in which the pixels or intensity maxima 7′ are hexagonally densely packed.

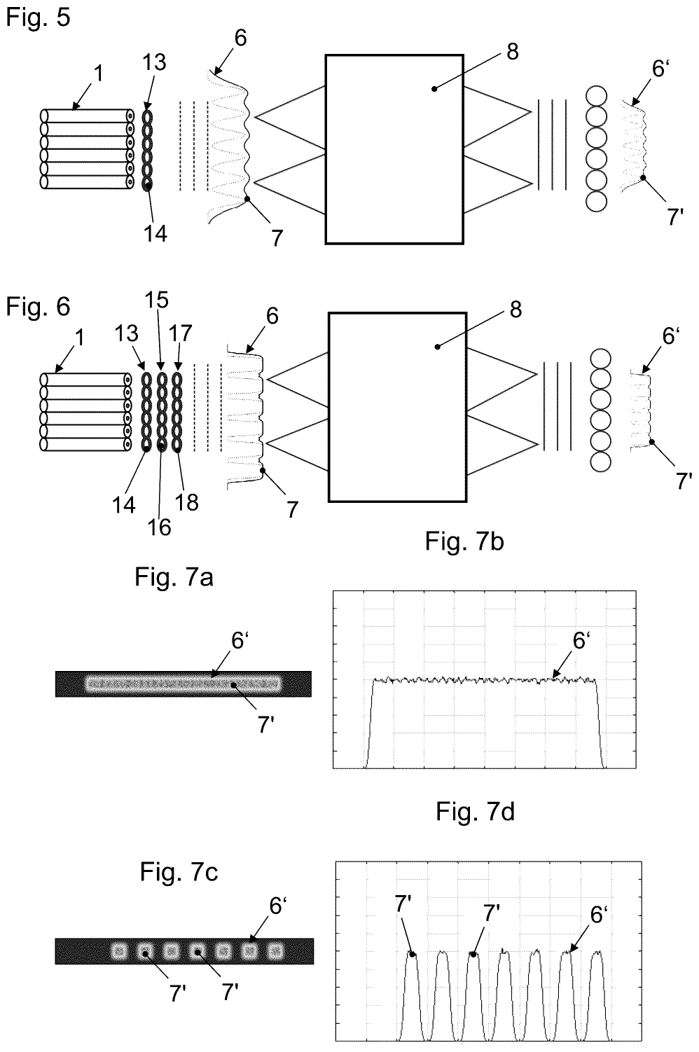

The embodiment illustrated in FIG. 5 corresponds essentially to that in FIG. 1. In contrast, the embodiment according to FIG. 5 comprises a schematically indicated additional array 13 of optical elements 14 between the laser light source 1 and the projection device 8. The optical elements 14 may be collimating lenses for collimating the laser radiation 2 emerging from the laser light source 1. Alternatively or additionally, the optical elements 14 may be imaging elements or telescopic elements to increase the depth of field of a focal plane generated in the first plane 5. For example, the optical elements 14 may image the fiber ends into the first plane 5. The optical elements 14 may be cylindrical or spherical in shape.

It is possible to provide two or more than two arrays 13 of optical elements 14 instead of one array 13 of optical elements 14. When two arrays 13 are used, the optical elements 14 of the two arrays 13 may, for example, be cylindrical lenses crossed with respect to each other.

The embodiment shown in FIG. 6 is substantially the same as that shown in FIG. 5. In contrast, the embodiment shown in FIG. 6 includes an additional array 15 of converters 16 and an additional array 17 of Fourier lenses 18. The converters 16, together with the Fourier lenses 18, can change the intensity profile of the laser radiation 2 or of one or more of the sub-radiations, where any one of the converters 16 can, for example, convert a Gaussian profile into a top-hat profile. Alternatively, each of the converters 16 may convert, for example, a Gaussian profile to an M-profile.

A converter may be provided that is configured as a 2D Gaussian-to-airy disc functions converter. Here, an Airy disc function corresponds to ˜J1(r)/r, where J1 is a Bessel function of the first kind. Such Airy disc functions are described, for example, in U.S. Pat. No. 9,285,593 B1. An example of a 2D Gaussian to Airy disc functions converter is an axisymmetric binary phase plate. Such a phase plate is described in U.S. Pat. No. 5,300,756.

A converter can also be provided which is designed as a 1D Gaussian-to-Sinc function converter. Here, a Sinc function corresponds to sin(x)/x. An example of a 1D Gaussian-to-Sinc function converter is two cylindrical binary phase plates oriented perpendicular to each other.

Such a converter as a 2D converter or two perpendicularly aligned 1D plates is used together with a Fourier lens as a Gauss-to-Tophat converter or Gauss-to-M-shape converter.

It is quite possible to provide more than one array 13 of optical elements 14 and/or more than one array 15 of converters 16 and/or more than one array 17 of Fourier lenses 18.

FIG. 6 schematically indicates that the intensity maxima 7 in the first plane 5 and the intensity maxima 7′ in the working plane 11 have a top-hat shape.

FIG. 7a and FIG. 7b show a line-shaped intensity distribution 6′ of the laser radiation 2 in the working plane 11 in a state in which all pixels and intensity maxima 7′, respectively, are present. In contrast, FIG. 7c and FIG. 7d show the intensity distribution 6′ in a state in which every second pixel is switched off. This shows that the intensity maxima 7′ in FIG. 7d have a top-hat profile.

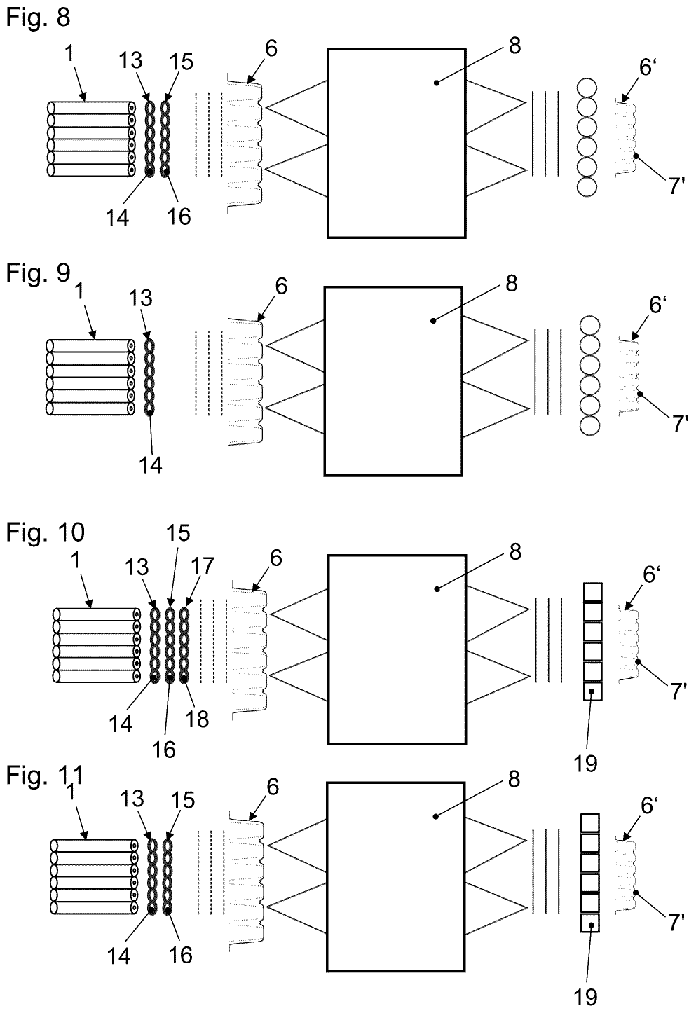

The embodiment illustrated in FIG. 8 corresponds essentially to that in FIG. 6. In contrast, the embodiment according to FIG. 8 comprises only one array 13 of optical elements 14, which may be designed, for example, as collimating lenses, and an additional array 15 of converters 16, the Fourier lenses being integrated into this array 15.

The embodiment illustrated in FIG. 9 corresponds essentially to that in FIG. 8. In contrast, the embodiment according to FIG. 9 comprises only an array 13 of optical elements 14, which may be designed, for example, as collimating lenses, the converters and the Fourier lenses being integrated into this array 15.

The embodiment shown in FIG. 10 corresponds essentially to that in FIG. 6. In contrast, in the embodiment according to FIG. 10 the cross-section of the intensity maxima 7′ or pixels is square. The cross-section is indicated in FIG. 10 by the squares 19 arranged next to each other. A square cross-section of the intensity maxima 7′ can be achieved, for example, by using crossed cylindrical lenses instead of spherical or aspherical circular lenses. These can be the lenses of the arrays 13, 17.

The embodiment illustrated in FIG. 11 corresponds essentially to that in FIG. 8. In contrast, in the embodiment according to FIG. 11, the cross-section of the intensity maxima 7′ or pixels is square. The cross-section is indicated in FIG. 11 by the squares 19 arranged next to each other.

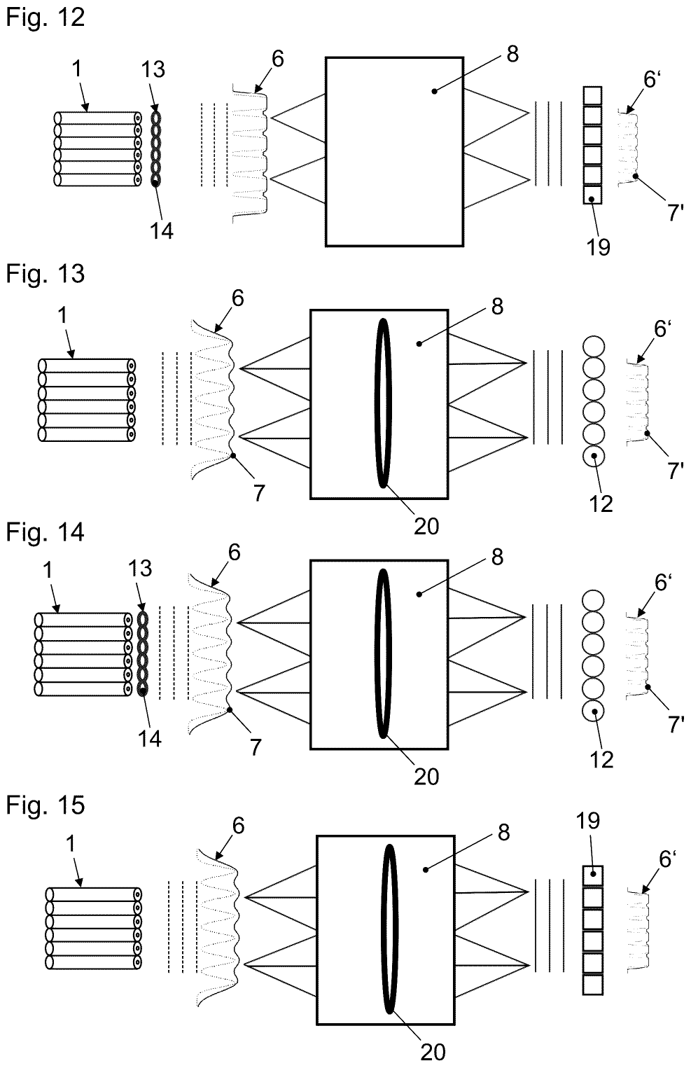

The embodiment illustrated in FIG. 12 corresponds essentially to that in FIG. 9. In contrast, in the embodiment according to FIG. 12 the cross-section of the intensity maxima 7′ or the pixels is square. The cross-section is indicated in FIG. 12 by the squares 19 arranged next to each other.

It is certainly possible to provide a hexagonal cross-section for the intensity distributions 7′ instead of a circular or a square cross-section.

In the embodiment according to FIG. 13, a converter 20 is provided within the projection device 8, which can change the intensity profile 6 of all partial beams of the laser radiation 2. The converter 20 can, for example, convert a Gaussian profile into a top-hat profile or a Gaussian profile into an M-profile. In the specific embodiment, the intensity maxima 7 in the first plane 5 have a Gaussian profile and the intensity maxima 7′ in the working plane 11 have a top-hat profile.

The converter 20 may be a 2D Gaussian-to-Airy disc functions converter. An example of a 2D Gaussian-to-Airy disc functions converter is an axisymmetric binary phase plate. The converter 20 may also be formed as a 1D Gaussian to Sinc function converter. An example of a 1D Gaussian-to-Sinc function converter is two cylindrical binary phase plates oriented perpendicular to each other. In either case, the second half of the projection lens 8, located behind the converter 20, may serve as a Fourier lens. However, another Fourier lens may alternatively be provided.

The converter 20 is arranged in the projection device 8 at a location where aperture stops are usually provided.

The embodiment illustrated in FIG. 14 corresponds essentially to that in FIG. 13. In contrast, the embodiment according to FIG. 14 comprises a schematically indicated additional array 13 of optical elements 14 between the laser light source 1 and the projection device 8. The optical elements 14 may be collimating lenses for collimating the laser radiation 2 emerging from the laser light source 1. Alternatively or additionally, the optical elements 14 may be imaging elements or telescopic elements to increase the depth of field of a focal plane generated in the first plane 5. For example, the optical elements 14 may image the fiber ends into the first plane 5. The optical elements 14 may be cylindrical or spherical in shape.

It is possible to provide two arrays 13 of optical elements 14 instead of one array 13 of optical elements 14.

The embodiment shown in FIG. 15 corresponds essentially to that in FIG. 13. In contrast, in the embodiment according to FIG. 15 the cross-section of the intensity maxima 7′ or pixels is square. The cross-section is indicated in FIG. 15 by the squares 19 arranged next to each other.

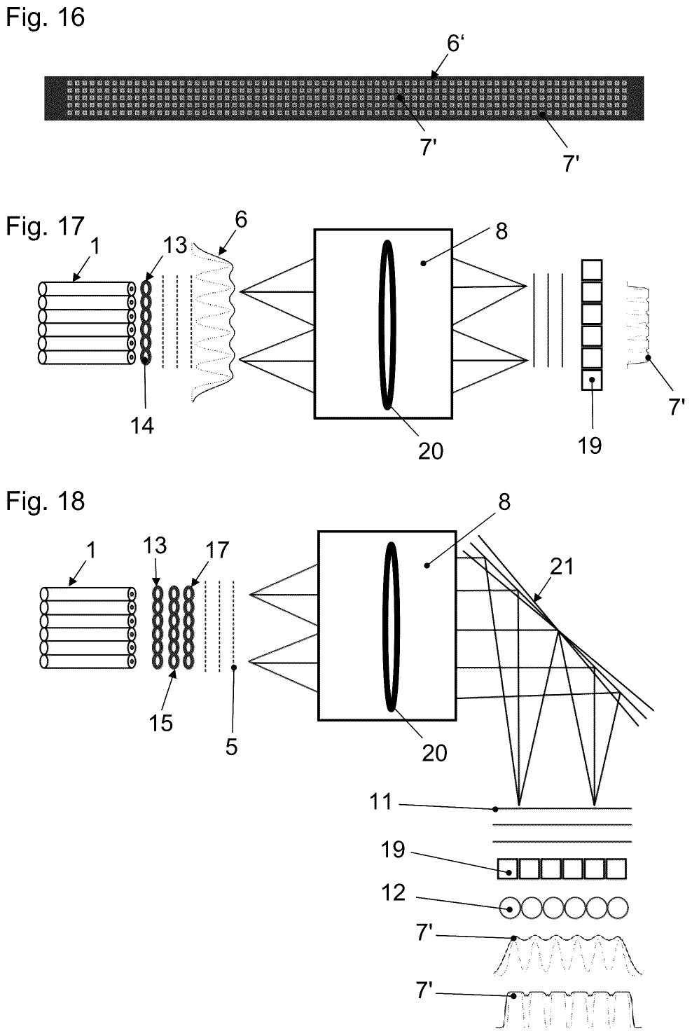

FIG. 16 shows an area-shaped or rectangular intensity distribution 6′ of the laser radiation 2 in the working plane 11 which can be generated by the laser device according to FIG. 15. For example, 5 by 150 pixels with a top-hat profile and a diameter of more than 100 μm can be provided. In the state shown in FIG. 16, every second pixel or intensity maximum 7′ is switched off.

The embodiment shown in FIG. 17 is essentially the same as that shown in FIG. 14. In contrast, in the embodiment shown in FIG. 17, the cross-section of the intensity maxima 7′ or pixels is square. The cross-section is indicated in FIG. 17 by the squares 19 arranged next to each other.

In the embodiment of a 3D printing device illustrated in FIG. 18, in addition to a laser device, a scanning device 21, which is merely indicated schematically, is provided for moving the laser radiation 2 in the working plane 11. The scanning device 21 can be designed, for example, as a polygon scanner or as a galvanometer scanner. In the embodiment example shown in FIG. 18, the scanning device 21 is arranged between the projection device 8 and the working plane 11.

The working plane 11 of the laser device can correspond to a working area of the 3D printing device, to which starting material to be exposed to the laser radiation 2 can be fed for 3D printing.

In the laser device according to FIG. 18, all of the alternatives shown in FIG. 1, FIG. 5, FIG. 6, FIG. 8 to FIG. 15 and FIG. 17 are indicated. Thus, both the arrays 13, 15, 17 in front of the projection device 8 and a common converter 20 in the projection device 8 are found there. Furthermore, both circles 12 and squares 19 are indicated in the working plane 11 as a possible cross-sectional shape of the pixels. Furthermore, both intensity maxima 7′ with a Gaussian profile and intensity maxima 7′ with a top-hat profile are indicated in the working plane.

It should be noted that these are alternatives which cannot or should not all be realized simultaneously or in one setup. Rather, the embodiments discussed with reference to FIG. 1, FIG. 5, FIG. 6, FIG. 8 to FIG. 15 and FIG. 17 are intended to be capable of being integrated into the 3D printing device shown in FIG. 18.

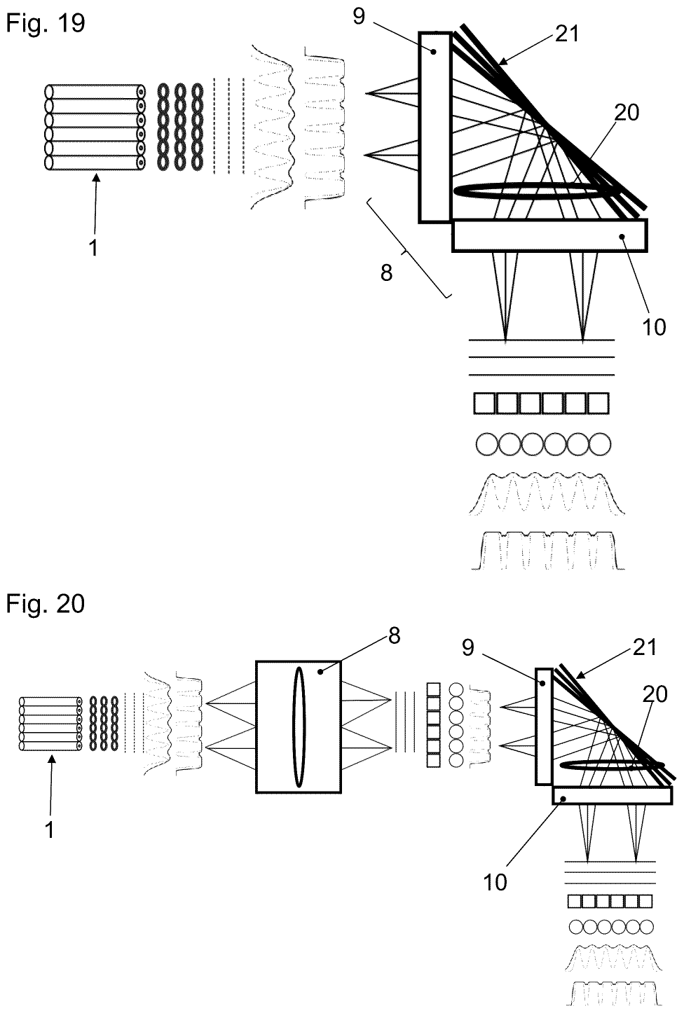

The embodiment illustrated in FIG. 19 is substantially the same as that illustrated in FIG. 18. In contrast, in the embodiment according to FIG. 19, the scanning device 21 is arranged in the projection device 8, in particular between first part 9 and a second part 10 of the projection device 8, with the common converter 20 being provided between the scanning device 21 and the second part 10. The two parts 9, 10 may form a Fourier transforming device. Thereby, the first part 9 may have, for example, a zoom function. Further, the second part 10 may serve, for example, as an F-theta lens or a flat field lens.

The embodiment illustrated in FIG. 20 corresponds essentially to that in FIG. 19. In contrast, in the embodiment according to FIG. 20, the projection device 8 is arranged in front of the scanning device 21, whereby the scanning device 21 can nevertheless be arranged in particular between two schematically indicated parts 9, 10 and in front of the common converter 20. Also in this case the two parts 9, 10 can form a Fourier transforming device. In this case, the first part 9 may have, for example, a zoom function. Further, the second part 10 may serve, for example, as an F-theta lens or as a flat field lens.

It should be noted here that at least one of the components 9, 10, 20 should be used, while the other components are optional.

In the embodiments of 3D printing devices illustrated in FIG. 18 to FIG. 20, the laser radiation 2 generated by the laser device can be deflected by the scanning device 21 as a whole.

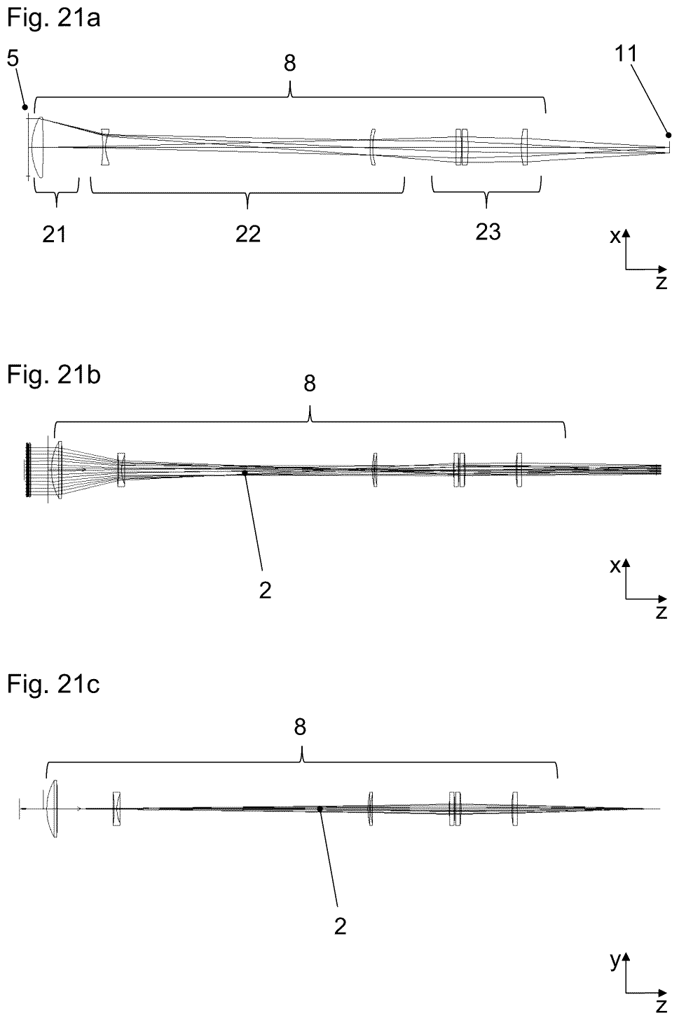

FIG. 21a to FIG. 21c illustrate a preferred embodiment of a projection device 8 that causes a reduction in size by a factor of 5 when imaging from the first plane 5 to the working plane 11. Three groups 22, 23, 24 of at least one lens each are provided in the projection device 8. Here, the first group 22 has a positive refractive power, the second group 23 has a negative refractive power, and the third group 24 again has a positive refractive power.

FIG. 21b and FIG. 21c show the passage of the laser radiation 2 through the projection device 8 in two mutually perpendicular directions x, y transverse to the propagation direction z.

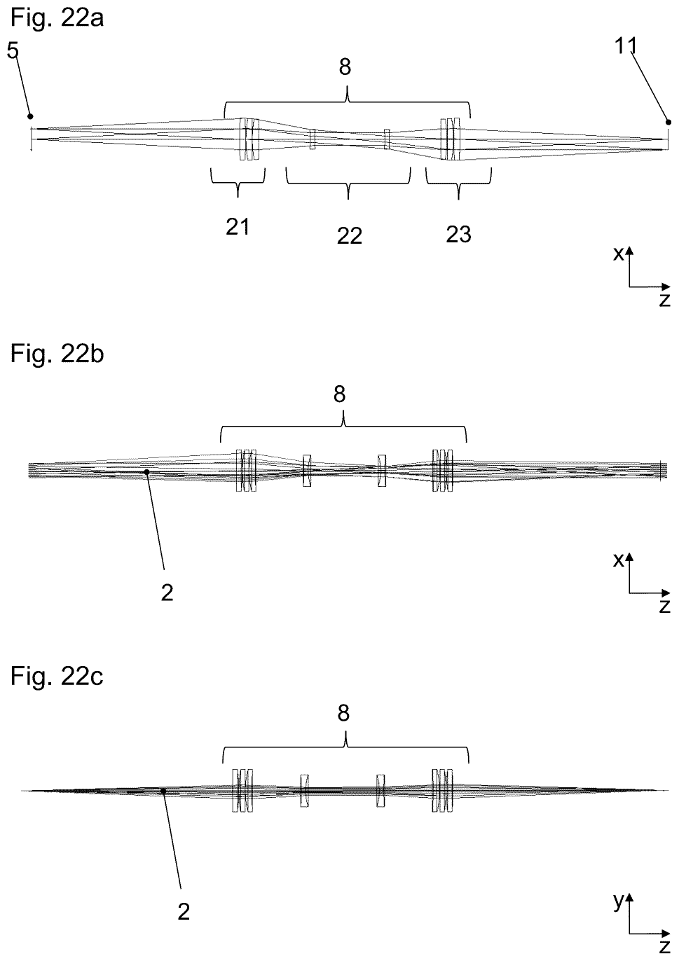

FIG. 22a to FIG. 22c show a likewise preferred embodiment of a projection device 8 that effects a 1:1 mapping from the first plane 5 into the working plane 11. In the projection device 8, again three groups 22, 23, 24 of at least one lens each are provided. Here, the first group 22 has a positive refractive power, the second group 23 has a negative refractive power, and the third group 24 again has a positive refractive power.

FIG. 22b and FIG. 22c show the passage of the laser radiation 2 through the projection device 8 in two mutually perpendicular directions x, y transverse to the direction of propagation z.

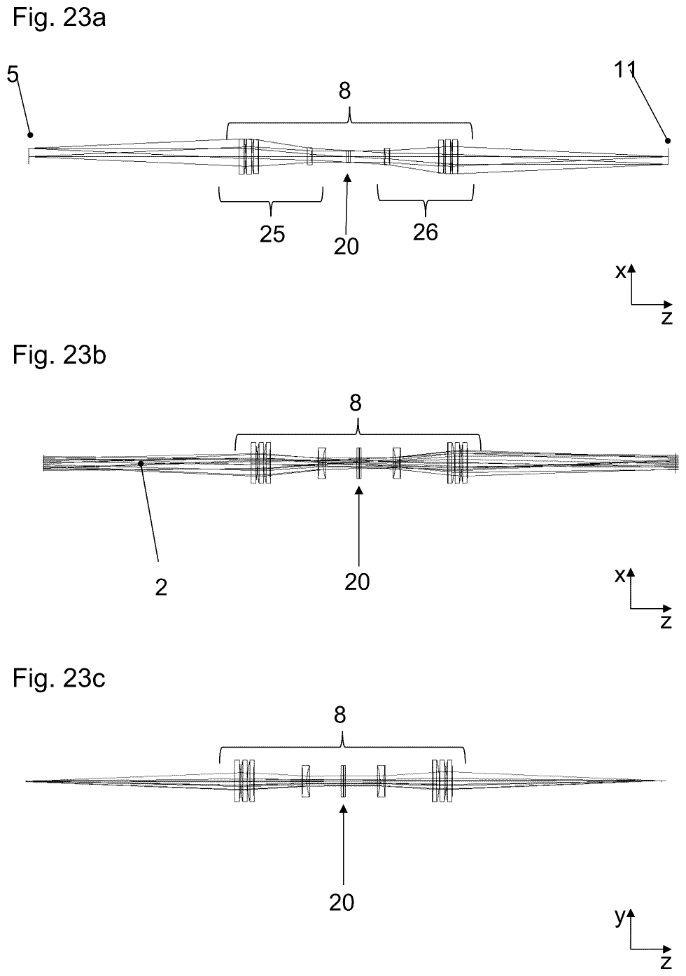

The projection device 8 shown in FIG. 23a to FIG. 23c corresponds to that shown in FIG. 22a to FIG. 22c except for an additional converter 20 which is arranged in the projection device 8 at a location where aperture diaphragms are usually provided. In the illustrated embodiment, the converter 20 consists of two Gaussian-to-top-hat converters arranged in series and crossed with respect to each other.

FIG. 23b and FIG. 23c show the passage of the laser radiation 2 through the projection device 8 in two mutually perpendicular directions x, y transverse to the propagation direction z.

The embodiment shown in FIG. 23a to FIG. 23c can be regarded on the one hand as a projection device or imaging device with an additional converter. Alternatively, the embodiment can also be understood as having the converter 20 arranged between a first Fourier transforming part 25 and a second Fourier transforming part 26.

It should be noted at this point that the projection device 8 has indeed been shown in the same way in FIGS. 1, 5, 6 and 8 to 12 and in FIGS. 13 to 18 and 20, respectively. Nevertheless, the projection device 8 shown in individual ones of the figures may have components or a structure or characteristics that differ from those of individual others or all of the other projection devices 8 in the other figures. Further, a different environment of the projection device 8, such as the addition of an array 13 (see FIGS. 1 and 5 or FIGS. 13 and 14), may change the imaging characteristics of the projection device 8, such as the distance from the first plane 5 to the working plane 11, even though the distance is simplified to be drawn the same in each of the figures.

It should further be noted that by imaging from the first plane 5 to the working plane 11, the order of the juxtaposed intensity maxima 7, 7′ and pixels, respectively, can be maintained or changed. Thus, for example, three pixels a-b-c arranged next to each other in the first plane 5 could also be arranged in the working plane 11 in the order a′-b′-c′ or, for example, in the order c′-b′-a′ or, for example, in the order b′-a′-c′.

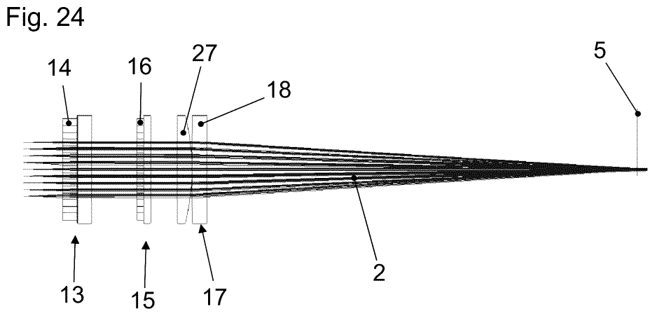

In the embodiment shown in FIG. 24, a two-dimensional array of, for example, 9 by 150 optical fibers, which are not shown, is provided from which the laser radiation 2 shown in FIG. 24 emanates. The embodiment comprises two arrays 13 of optical elements 14, which are formed as cylindrical lenses and serve for collimation. The cylindrical axes of the cylindrical lenses on the two arrays 13 are aligned perpendicular to each other or are formed as cylindrical lenses crossed with each other.

The embodiment according to FIG. 24 further comprises two arrays 15 of converters 16 crossed with respect to each other. Furthermore, the embodiment comprises a Fourier lens 27 and an array 17 of Fourier lenses 18 connected thereto. The converters 16 together with the Fourier lenses 18 can change the intensity profile of the laser radiation 2 or of one or more of the partial beams, wherein each of the converters 16 can, for example, convert a Gaussian profile into a top-hat profile. Alternatively, each of the converters 16 may, for example, convert a Gaussian profile into an M-profile.

The nine partial beams of laser radiation 2 running side by side in the vertical direction in FIG. 24 are combined with each other in the first plane 5 by the Fourier lens 27, so that a line-shaped intensity distribution with 1 by 150 pixels is generated there. The intensity distribution is imaged from the first plane 5 into the working plane 11 by the projection device not shown.

1. A laser device for generating laser radiation which has an intensity distribution with a plurality of intensity maxima in a working plane, comprising
a laser light source which, during operation of the laser device, emits a laser radiation which, in a first plane, forms a linear or planar intensity distribution having a plurality of intensity maxima;
a projection device which images the first plane into the working plane in such a way that a line-shaped or area-shaped intensity distribution with a plurality of intensity maxima is formed in the working plane.

2. The laser device according to claim 1, characterized in that the intensity maxima of the intensity distribution in the first plane are at least partially at a first distance from one another in at least one transverse direction which is perpendicular to the propagation direction of the laser radiation, wherein the projection device images the first plane in a reduced form into the working plane in such a way that the intensity maxima of the intensity distribution in the working plane in at least one transverse direction, which is perpendicular to the direction of propagation of the laser radiation, are at least partially at a second distance from one another, which is smaller than the first distance.

3. The laser device according to claim 1, characterized in that the intensity maxima of the intensity distribution in the first plane in at least one transverse direction, which is perpendicular to the propagation direction of the laser radiation, at least partially have a first distance from one another, the projection device imaging the first plane into the working plane in such a way, that the intensity maxima of the intensity distribution in the working plane in at least one transverse direction, which is perpendicular to the propagation direction of the laser radiation, at least partially have a second distance from one another, which is greater than the first distance or which is equal to the first distance.

4. The laser device according to claim 2, characterized in that the intensity maxima in the working plane in the at least one transverse direction all have the second distance from one another.

5. (canceled)

6. (canceled)

7. (canceled)

8. (canceled)

9. (canceled)

10. (canceled)

11. The laser device according to claim 1, characterized in that the laser light source comprises at least one fiber laser.

12. The laser device according to claim 1, characterized in that the laser light source comprises a plurality of optical fibers, from the ends of which a partial radiation of the laser radiation emerges in each case.

13. The laser device according to claim 12, characterized in that the laser light source comprises a holder with a plurality of grooves, wherein each of the optical fibers is arranged in one of the grooves.

14. The laser device according to claim 13, characterized in that a one-dimensional or two-dimensional array of optical fibers is formed by connecting the optical fibers or their ends directly, for example by bonding and/or splicing, to an optical component or to a window.

15. The laser device according to claim 12, characterized in that the intensity maxima generated in the first plane are each formed by the partial radiation emerging from one of the optical fibers.

16. The laser device according to claim 12, characterized in that the partial radiations in the individual optical fibers have a mode profile which corresponds to a Bessel profile or a Gaussian profile or an M profile or a top-hat profile.

17. (canceled)

18. The laser device according to claim 1, characterized in that the laser device comprises at least one converter capable of changing the intensity profile of the laser radiation or of one or more of the partial beams, the converter being capable, for example, of converting a Gaussian profile into a top-hat profile.

19. The laser device according to claim 18, characterized in that the at least one converter is 2D Gaussian-to-ary disc function converter, or in that the at least one converter is 1D Gaussian-to-sinc function converter.

20. The laser device according to claim 18, characterized in that a plurality of converters are provided, arranged in a one-dimensional or a two-dimensional array.

21. The laser device according to claim 18, characterized in that the at least one converter is integrated into the projection device.

22. (canceled)

23. The laser device according to claim 1, characterized in that the laser device comprises at least one collimation element, for collimating the laser radiation emerging from the laser light source.

24. (canceled)

25. The laser device according to claim 1, characterized in that the plurality of intensity maxima in the working plane can be switched on or off individually or in groups.

26. The laser device according to claim 1, characterized in that the laser device comprises means for superimposing individual partial beams emanating from the laser light source into individual pixels in the first plane and/or in that the laser device comprises means for splitting individual or all partial beams emanating from the laser light source into a plurality of pixels in the first plane.

27. The laser device according to claim 1, characterized in that the laser device comprises at least one Fourier lens and/or at least one array of Fourier lenses.

28. A 3D printing device for generating a spatially extended product, comprising
a laser device for generating laser radiation, which has an intensity distribution with a plurality of intensity maxima in a working plane,
a working area to which the starting material for 3D printing to be acted upon by the laser radiation is or can be supplied, the working area being arranged in the 3D printing device in such a way that the laser radiation impinges on the working area, as well as
a scanning device which can selectively supply the laser radiation to different locations in the working area,
characterized in that the laser device is a laser device according to claim 1.

29. The laser device according to claim 3, characterized in that the intensity maxima in the working plane in the at least one transverse direction all have the second distance from one another.
